(19) United States
(12) Patent Application Publication
(10) Pub. No.: US 2013/0173853 A1
(43) Pub. Date: Jul. 4, 2013

(54) MEMORY-EFFICIENT CACHING METHODS AND SYSTEMS

(71) Applicant: NEC LABORATORIES AMERICA, INC., Princeton, NJ (US)

(72) Inventors: Cristian Ungureanu, Princeton, NJ (US); Biplob Kumar Debnath, Franklin Park, NJ (US); Stephen Rago, Warren, NJ (US); Akshat Aranya, Jersey City, NJ (US)

(73) Assignee: NEC LABORATORIES AMERICA, INC., Princeton, NJ (US)

(21) Appl. No.: 13/627,489

(22) Filed: Sep. 26, 2012

Related U.S. Application Data
(60) Provisional application No. 61/539,150, filed on Sep. 26, 2011.

(51) Int. Cl. G06F 12/08; G06F 12/02; G06F 12/12

(52) U.S. Cl. CPC G06F 12/0891; G06F 12/122; G06F 12/0246
USPC 711/103; 711/135; 711/136

(57) ABSTRACT

Caching systems and methods for managing a cache are disclosed. One method includes determining whether a cache eviction condition is satisfied. In response to determining that the cache eviction condition is satisfied, at least one Bloom filter registering keys denoting objects in the cache is referenced to identify a particular object in the cache to evict. Further, the identified object is evicted from the cache. In accordance with an alternative scheme, a bit array is employed to store recency information in a memory element that is configured to store metadata for data objects stored in a separate cache memory element. This separate cache memory element stores keys denoting the data objects in the cache and further includes bit offset information for each of the keys denoting different slots in the bit array to enable access to the recency information.

### RELATED APPLICATION INFORMATION

This application claims priority to provisional application Ser. No. 61/539,150 filed on Sep. 26, 2011, incorporated herein by reference.

### BACKGROUND

1. Technical Field

The present invention relates to caching systems and methods and, more particularly, to efficient management of metadata for caching systems and methods.

2. Description of the Related Art

One important aspect of caching systems is the determination of which objects to evict from the cache as new objects are inserted into the cache. LRU (Least Recently Used) is one commonly used scheme that proposes to evict the object that was used least recently. To determine the least recently used object, a doubly linked list is maintained in the order of accesses, from most-recently used to least-recently used. On an access to any object in the cache, this object is removed from its current place in this doubly linked list and moved to the most-recently used position.

To quickly find this object in the list, an in-memory cache keeps a dictionary mapping this object (or the object's unique key) to the position in the list. In other algorithms, the dictionary maps the object's key to some access information. For N cached objects, just this dictionary requires at least (N log N) bits. In the case of a cache with 4 billion objects, log N is 32, and the dictionary occupies 16 GB of random access memory (RAM). Separate from the dictionary, caching systems employ some data structure to keep track of access information, either explicitly or implicitly.

### SUMMARY

One embodiment of the present principles is directed to a method for managing a cache. In accordance with the method, a determination of whether a cache eviction condition is satisfied is made. In response to determining that the cache eviction condition is satisfied, at least one Bloom filter registering keys denoting objects in the cache is referenced to identify a particular object in the cache to evict. Further, the identified object is evicted from the cache.

Another embodiment is directed to a caching system. The system comprises a main storage element, a cache and a processor. The main storage element is configured to store data and the cache is configured to store data objects and metadata for the data objects that includes at least one Bloom filter. Further, the processor is configured to reference the Bloom filter(s), which registers keys denoting the data objects in the cache, to identify which of the data objects in the cache to evict in response to determining that a cache eviction condition is satisfied.

An alternative embodiment is also directed to a caching system. The system includes a main storage element, a cache and a processor. The main storage element is configured to store data and the cache includes at least one first element configured to store metadata for data objects that includes a bit array and at least one second element configured to store the data objects. The second element(s) includes keys denoting the data objects in the cache and includes bit offset information for each of the keys denoting different slots in the bit array. Further, the processor is configured to identify, in response to determining that a cache eviction condition is satisfied, a particular data object in the cache to evict by determining whether the slot in the bit array corresponding to the particular data object indicates that the particular data object was recently used.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a caching system in accordance with exemplary embodiments of the present principles;

FIG. 2 is a block diagram of an overview of exemplary embodiment of efficient caching methods and systems in accordance with the present principles;

FIG. 3 is a block/flow diagram of a prior art caching system;

FIG. 4 is a block/flow diagram of a caching system in accordance with exemplary Bloom filter-based embodiments of the present principles;

FIG. 5 is a block/flow diagram of a caching system in accordance with exemplary back-pointer-based embodiments of the present principles;

FIG. 6 is a block/flow diagram of a method for managing a cache in accordance with an exemplary embodiment of the present principles;

FIG. 7 is a block/flow diagram of a method for managing a cache by employing a Bloom filter with a deletion operation in accordance with an exemplary embodiment of the present principles;

FIG. 8 is a block/flow diagram of a method for managing a cache by employing a plurality of Bloom sub-filters in accordance with an exemplary embodiment of the present principles; and

FIG. 9 is a block/flow diagram of a method for managing a cache by employing an in-memory bit array in accordance with an exemplary embodiment of the present principles.

### DETAILED DESCRIPTION OF PREFERRED EMBODIMENTS

As indicated above, recency-based cache replacement policies rely on an in-RAM full index dictionary, typically a B-tree or a hashtable, that maps each object to its recency information. Even though the recency information itself may take very little space, the full index for a cache holding N keys requires at least log N bits per key. Thus, current methods for managing caches use a relatively large amount of memory for its metadata, which becomes a significant problem when they are used to manage large-capacity caches. For example, recent advances have made flash-memory-based solid-state disks (SSDs) an attractive option for use as caches. SSDs have much higher random input/output (I/O) performance than that of a standard hard disk, and, compared to RAM, they have much higher capacity (density), are less expensive, and use less power per bit—thus, making them attractive to use as an additional, or even an only, cache layer. Flash-based caches are especially attractive for storing popular objects for large disk-based key-value stores. At a first approximation, the performance of the system is determined by the cache miss rate. One way to reduce the miss rate is to use larger caches and flash memory systems provide an affordable option for building very large caches.

Recency-based caching algorithms, as indicated above, use two data structures: an access data structure that maintains the recency information, and an index that maps an object's key to its associated recency information. However, as also noted above, known schemes require a large amount of memory for the access data structure and the index, making them undesirable for use with large capacity caches, such as flash-based caches. Further, keeping metadata information on the cache is also unattractive, as it would result in significant write activity to the flash cache, as the access information is updated even on read hits.

To avoid the problems caused by keeping the caching policy metadata on flash, or a full index in memory, the present principles employ novel memory-efficient caching policies that maintain the access information in memory in Bloom filters or in a bit-array in a manner that approximates, but does not require, a full index. In accordance with one aspect, the on-flash key-value store can be employed to traverse the cached keys in order to select eviction victims. In addition to being memory-efficient, the caching schemes described herein are agnostic to the organization of data on the cache. Thus, the schemes can be employed with any existing key-value store implementations that provide a traversal operation, which is common in most key-value stores. Thus, users are free to choose their preferred key-value store design.

Note that keeping approximate information in Bloom filters for access does not mean that a key that is present in the cache will be nevertheless considered a miss; mapping keys to values is performed by the key-value store implementation, which is exact. The access information is only used to decide evictions, when the cache is full and a new object is inserted in it, for example, during a new write, or a read cache miss. To select a victim, the key-value store on flash can be used to iterate over its keys; if the key is present in the Bloom filter, the object is considered to have been accessed recently and is not evicted; otherwise, the object is evicted from the cache. Table 1, below, summarizes the metadata memory usage for a cache management method that uses a Bloom filter and an existing key-value store as a cache, described herein below. The table compares the method to LRU and CLOCK. The method adds a one byte of overhead per object to the memory usage of the key value store. Although, at one extreme, there are key-value stores that require a full in-memory index regardless, there also exist many implementations that limit the amount of memory used. Table 1 summarizes memory usage for a 1 TB cache containing varying sized objects. It is assumed that keys are 4 bytes, the index is a hashtable with open addressing and a load factor of 0.5, and the pointers in LRU are 8 bytes.

TABLE 1
Memory Usage Comparison

| | |
|---|---|
| Caching | Object Size |

| Scheme | 1 MB | 4 KB | 1 KB | 256 B |
|---|---|---|---|---|
| LRU | 24 MB | 6 GB | 24 GB | 96 GB |
| CLOCK | 8 MB | 2 GB | 8 GB | 32 GB |
| Present Method | 1 MB | 0.25 GB | 1 GB | 4 GB |

It is noted that traditional Bloom filter designs do not support a delete operation. In accordance with one aspect of the present principles, a Bloom filter is provided with a key delete operation. Alternatively, a plurality of Bloom sub-filters can be employed, where one of the sub-filters is periodically purged and discarded. The two implementations enable the Bloom filter to track changes to the sets of cached objects through both additions (insertions) and evictions (deletions). In accordance with an alternative embodiment, to achieve even more memory efficiency, an in-memory bit array can be employed to track cached objects. Here, the capability of the on-flash key-value store to iterate over cached objects can be leveraged in order to perform a search for eviction candidates.

It should be understood that embodiments described herein may be entirely hardware or may include both hardware and software elements. In a preferred embodiment, the present invention is implemented in hardware and software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Prior to discussing embodiments of the present principles in more detail, certain aspects of known caching systems should be discussed for expository purposes to illustrate certain advantages provided by the present principles. For example, in known caching systems, in-memory caches hold both data (the objects that need to be cached), as well as metadata necessary for the functioning of the cache, such as doubly-linked lists for the LRU policy. For example, in a conventional system, RAM, capable of storing gigabytes of data, provides a primary cache on which both cache-data objects and the cache-metadata are stored. The space occupied by metadata is usually relatively much smaller than that occupied by data. However, newer, higher-performance, storage technologies, such as flash storage, can provide a substantial amount of storage. As a result, if such storage technologies are employed for caching purposes, then the metadata for the cache can become prohibitively large. In particular, since the cache sizes that are practical for flash are much larger than those practical for memory, the amount of metadata that needs to be maintained grows accordingly, and the memory overhead of this metadata becomes a serious concern.

For example, suppose a computer system has 16 GB of RAM that is used as a primary cache. Further, suppose that the cached objects are about 4 KB each, and the cache metadata overhead is 16 bytes per object. Thus, the cache metadata requires at most about 4% of the memory (16 bytes/4 KB), and the primary cache can hold ˜4 million objects 16 GB/(4 KB+16). Now suppose a secondary cache (in addition or even in lieu of a primary cache) is added and implemented with flash storage. If we have 16 TB of a solid state drive (SSD), the secondary cache can hold about 16 TB/4 KB, or 4 billion objects. The cache-metadata requirement becomes 64 GB (16 bytes×4 billion). Thus, it is desirable to use more memory-efficient cache-metadata structures.

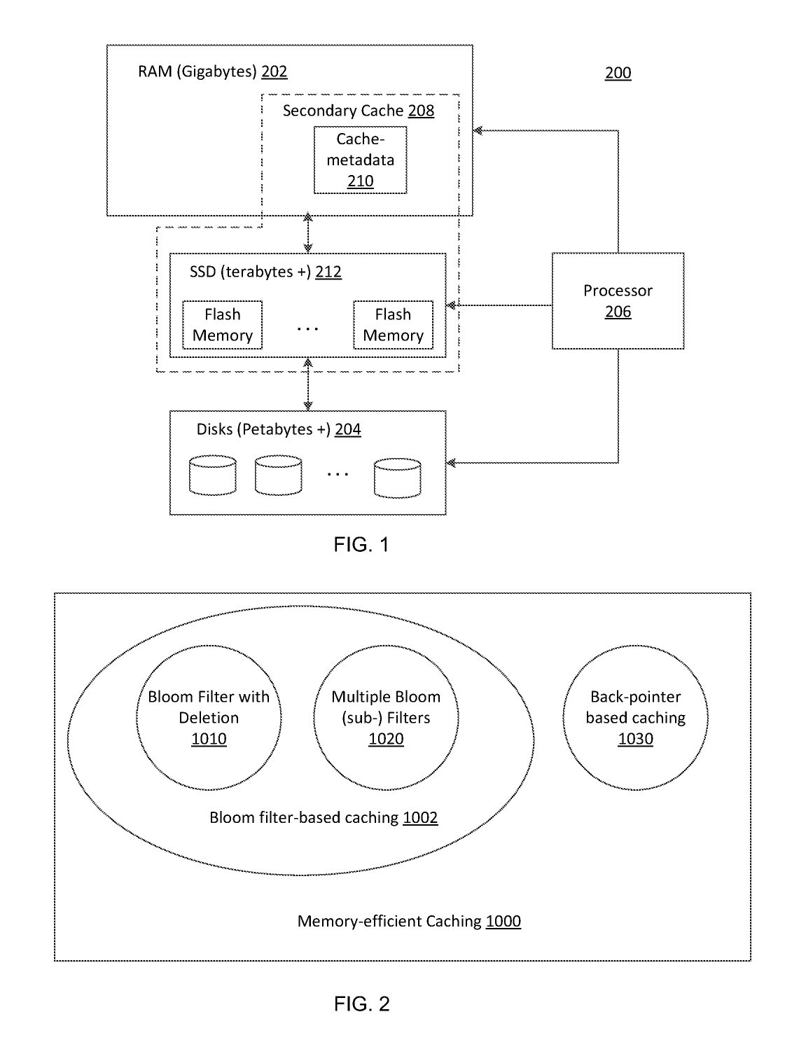

The present principles introduce caching systems and methods that have very low memory usage per cached object, thereby making it suitable for very large secondary caches. The present principles can employ higher performance storage technologies, such as flash storage, as a second-level cache for disk storage. In such a secondary cache system, the data is stored on cache, but metadata (such as access information for each object in the cache) is kept in memory. For example, as illustrated in the system 200 of FIG. 1, the secondary cache 208 is formed on both RAM 202, capable of storing gigabytes of data, and flash storage composed of SSDs 212. Here, cache-metadata 210 is stored in the RAM 202 and data objects for which the cache-metadata 210 is generated are stored in the fash memory of the SSD 212. The processor 206 manages the metadata 210 and the transfer of data objects from the main storage disks 204, capable of storing petabytes of data, to the cache SSD 212. Because a secondary cache can hold many more objects on SSD than a primary cache can hold in RAM, the memory used for cache metadata increases significantly. It should be noted that flash memory is only one implementation of the cache 212. Other high performance memory systems can be employed as the cache 212 in accordance with the methods described herein.

Recency-based caching algorithms need an access data structure that tracks accesses to objects. In-memory caching algorithms can maintain this data structure by leveraging the in-memory index they use to locate the objects. Thus, these schemes require the use of access information indicating recency of use as well as index information to correlate an object to its recency information. For example, the CLOCK algorithm uses an extra bit (variations exist that use several bits) to be kept together with the key of each object in the cache. However, for very large caches on flash, keeping an in-memory index is prohibitive. Thus, in accordance with the present principles, maintaining the access information is implemented in a different manner.

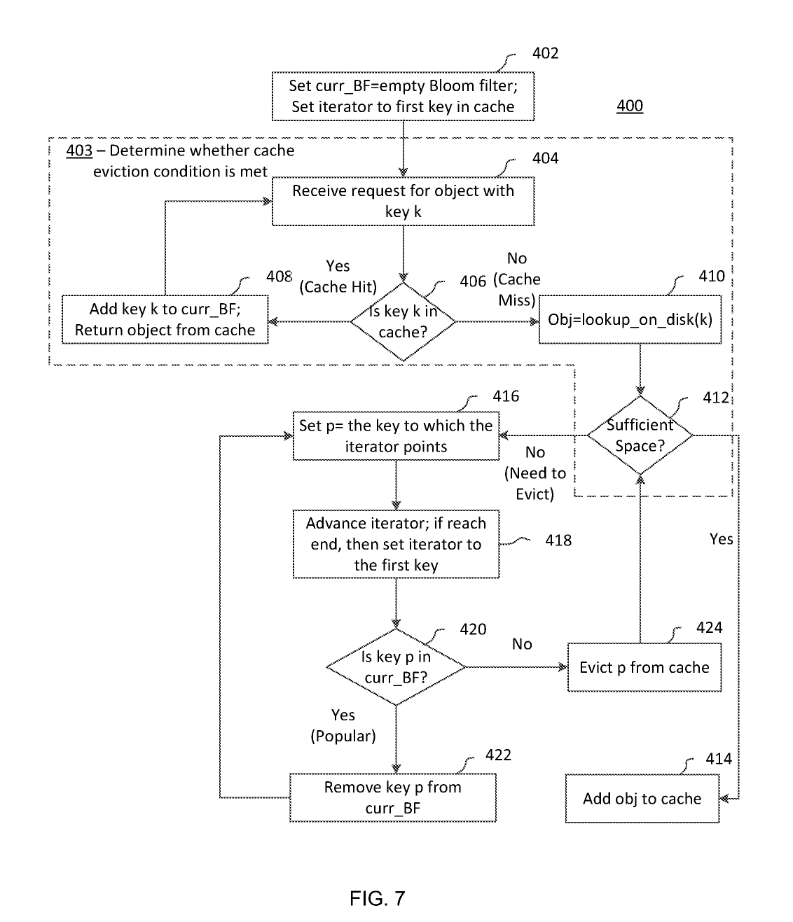

The present principles provide a means for separating access information from index information. The access information can be maintained efficiently in RAM, while the index can span both the RAM and the SSD, or only the SSD. The underlying object storage, such as a key-value storage system, can be employed to iterate through the keys. Thus, all of the keys for objects in the cache need not be maintained in the RAM. Instead of maintaining an in-memory dictionary, which permits exact knowledge of the access information for every key, the present principles include at least three different data structure schemes that can be used to implement recency-based policies. In accordance with one aspect, an approximation achieving the performance of CLOCK (itself an approximation of LRU) is employed without an expensive in-memory index. The first and second data structures are based on Bloom filters, which enable only an approximate association of a key with its access information. Approximate association in this sense means that the data structure might have false positives, in which the key is deemed accessed even if it was not, or might have false negatives, in which the key is deemed not accessed even if it was. In such cases, the choice of eviction might be less than ideal, but this does not present a correctness issue; as long as false positives and negatives do not happen often, the methods will behave well. The first data structure employs a Bloom Filter with an added deletion operation and is referred to here as Bloom filter with deletion (BFD). To remove a key from the Bloom Filter, all of the bits returned by the Bloom Filter hashing functions are reset, as discussed in more detail herein below with respect to FIG. 7.

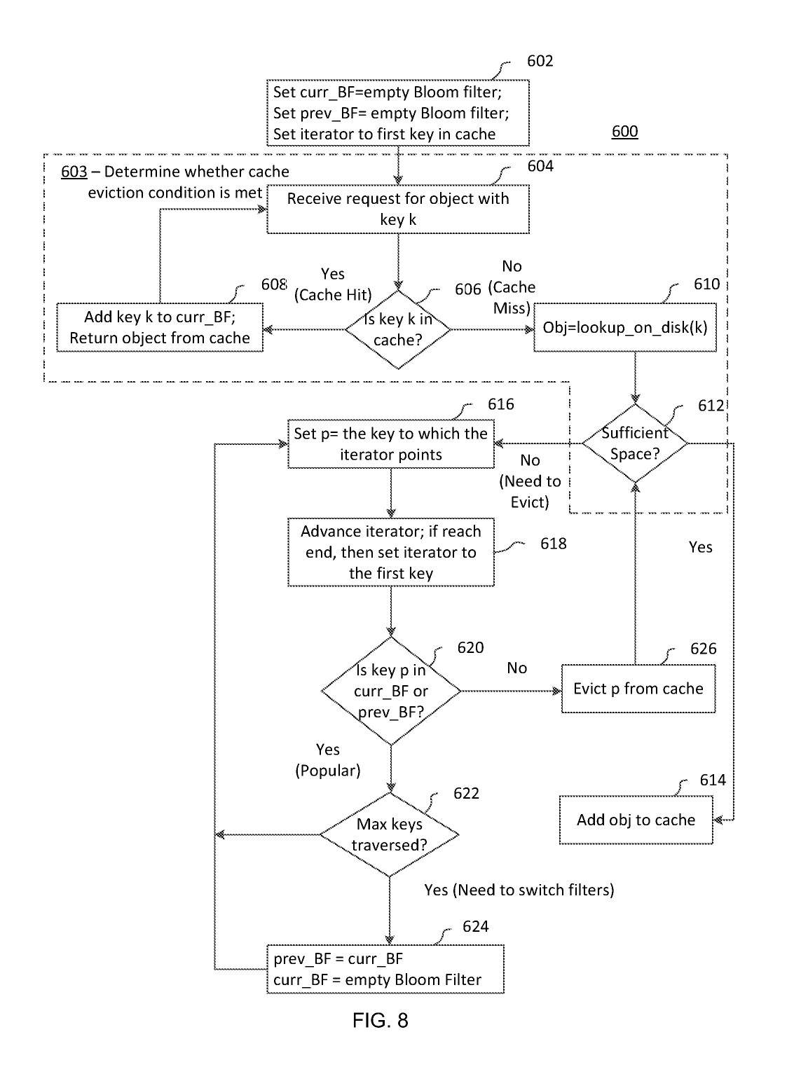

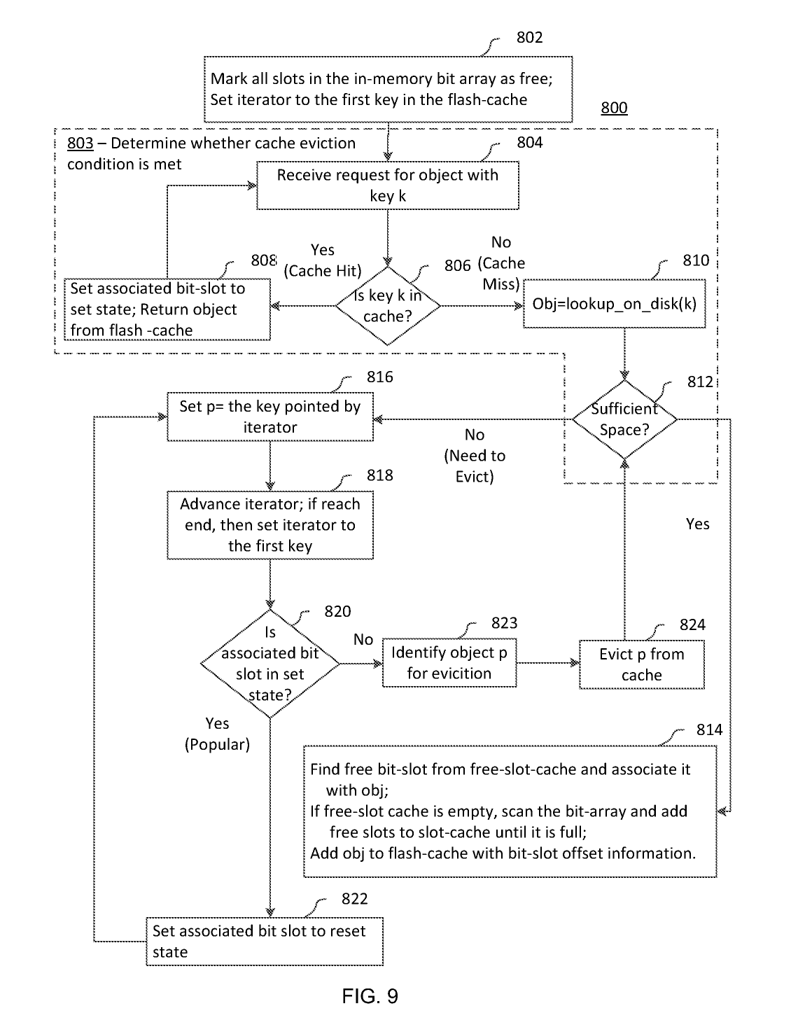

The second data structure type is a variation in which a plurality of standard Bloom Filters, which do not need a deletion operation, are utilized. In accordance with one embodiment, discussed below with respect to FIG. 8, two Bloom filters are employed for this purpose, where one “current” Bloom filter and one “previous” Bloom filter are used. This embodiment is referred to here as TBF, two Bloom sub-filters (regular, without deletion). When certain conditions are met, such as, for example, when a cache traversal is completed, the “previous” Bloom filter is discarded, the “current” becomes “previous,” and “current” is initialized to a new (empty) Bloom filter. Each key access that hits in the cache, is inserted into the “current” Bloom filter (BF). If the key access is a miss, the object is looked-up on disk, after which the object is inserted into the cache; a further variation involves a determination of whether this new key should be inserted into the Bloom filter. This represents a trade-off between the traversal cost of finding a key that is not in the Bloom filter and the amount of “grace-time” a new key is given before eviction. The third embodiment employs an in-memory bit array that obviates the need for an in-memory dictionary by employing a back-pointer and by leveraging the capability of the on-flash key-value store to iterate over cached objects in order to perform a search for eviction candidates, as discussed in more detail herein below with respect to FIG. 9.

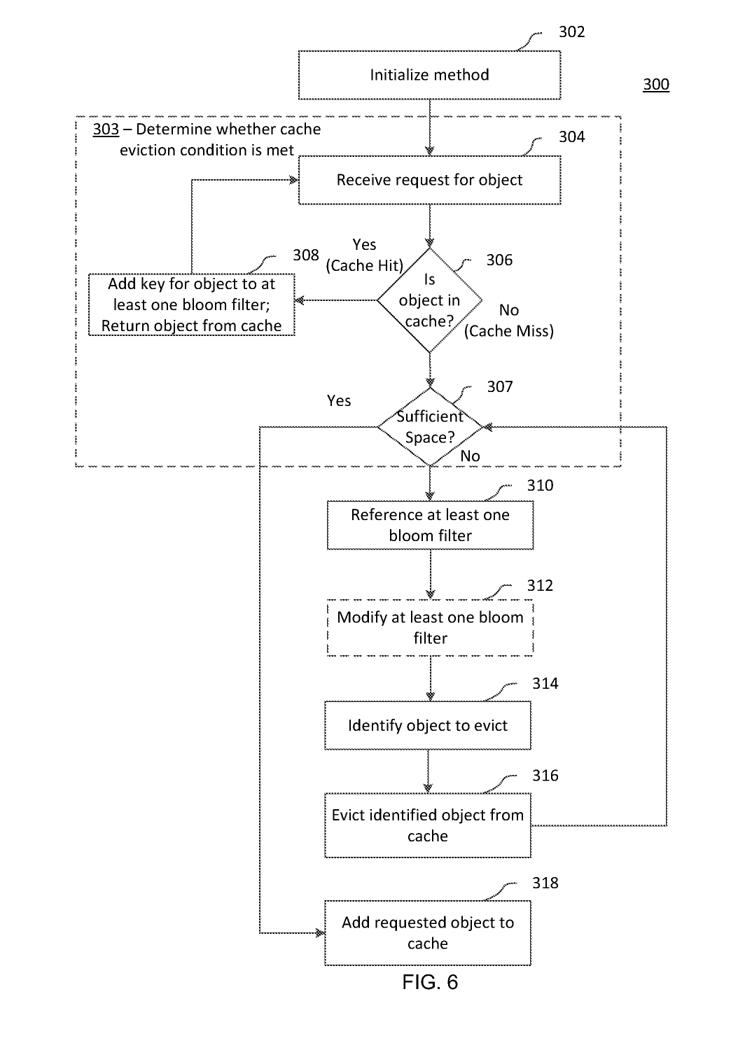

Referring now to FIG. 2, an overview 1000 of memory efficient caching embodiments in accordance with the present principles is illustratively depicted. The memory efficient caching schemes include Bloom filter-based caching schemes 1002 and back-pointer-based caching schemes 1030. For example, the Bloom-filter based caching schemes are generally described herein below with respect to FIG. 6, while an example of a back-pointer-based caching scheme is described with respect to FIG. 9. Examples of Bloom-filter based caching schemes include Bloom filter with deletion (BFD) schemes 1010 and multiple Bloom (sub-)filter schemes 1020. A detailed description of an exemplary BFD scheme is provided below with respect to FIG. 7, while an example of a multiple Bloom (sub-)filter scheme in which two bloom filters (TBF) are employed is discussed with respect to FIG. 8. The schemes 1010 and 1020 differ in the manner in which access information is implemented. For example, in accordance with the exemplary BFD schemes 1010 described herein, when the store is traversed to find a cache victim for eviction, any object that is deemed to be an inadequate eviction victim is removed from the Bloom filter. The removal here is utilized to effect an “aging” of objects in the cache that were previously denoted as being recently used. However, in the exemplary multiple Bloom filter schemes 1020 described herein, deletions from the Bloom filter need not be employed every time objects are traversed during searches for victims. Rather, periodically, for example, at a set threshold based on time, the elements traversed, etc., the Bloom filters are “aged” by discarding a subset of the keys (i.e., the keys in the oldest sub-filter). The back-pointer-based caching schemes 1030 need not employ a Bloom filter; here, as discussed in more detail herein below with respect to FIG. 9, a bit-array is employed to determine recency information using even fewer bits per object than the exemplary Bloom filter-based schemes described herein.

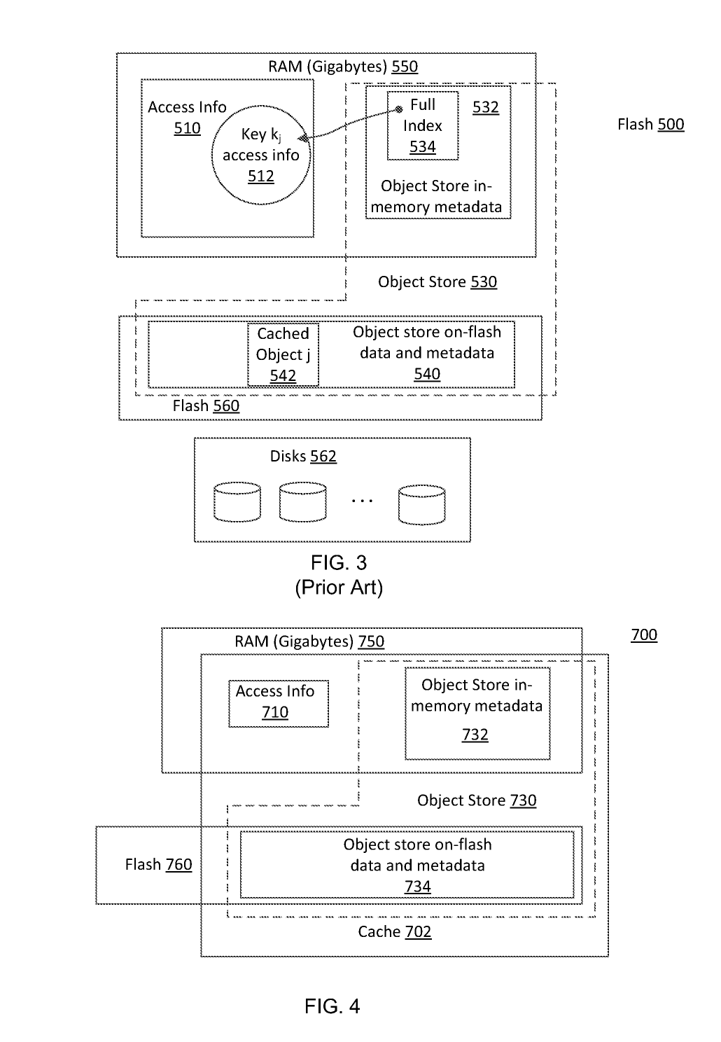

With reference now to FIG. 3, a caching system 500 in accordance with a prior art scheme is illustratively depicted for comparison purposes. The system 500 is comprised of a RAM 550, flash memory 560 and hard disks 562. An object store 530 is comprised of object store in-memory metadata 532 on RAM 550 and object store on-flash data and metadata 540 on the flash memory 560. The hard disks 562 stores data objects and the object store 530 is employed as a cache for a subset of the data objects. Here, access information 510 is stored in the RAM 550 and includes recency information of each key kⱼ 512 of each corresponding cache object 542 stored in the flash 560 of the object store 530. In addition, the RAM 550 also stores a full index 534 in the object store in-memory metadata 532. The algorithms implemented by this system rely on a full in-memory index 534 in order to locate access information 512 of an accessed object 542. As indicated above, in accordance with this scheme, the full memory index 534 requires a minimum of log₂ N bits per object. In contrast, exemplary schemes of the present principles need not employ any in-memory index 534 and can utilize as little as one bit per object in the access information, depending on the implementation used.

FIG. 4 illustrates an exemplary system 700 in which Bloom filter-based methods, such as the methods 300, 400 and 600 of FIGS. 6, 7 and 8, respectively, described below, can be implemented. Here, the RAM 750 is an implementation of the RAM 202 of the system 200 and the flash memory 760 is an implementation of the SSD 212. The system 700 can further include the processor 206 and the disks 204 of the system 200. The cache 702 is an implementation of the cache 208 and is comprised of at least portions of the RAM 750 and the flash memory 760. Further, the access information 710 for each cached object is an implementation of the metadata 210 and is stored in the RAM 750. The system 700 further includes an object store 730, which includes object store in-memory metadata 732 and object store on-flash data and metadata 734. The RAM 750 also stores object store in-memory metadata 732, the size of which can vary depending on the implementation of the type of memory 760 employed. Indeed, the metadata 732 can be omitted entirely, as any such indices employed by the object store 730 can be stored in the flash 760. In addition, the object store data and metadata 734 can be stored in the flash 760. A significant advantage of the system 700 is that it does not require a full in-memory index. In accordance with exemplary aspects of Bloom filter-based schemes, 8 bits of the RAM 750 (in their BFs) can be used per object in the access information 710. The in-memory component 732 of the object store may be small, or even omitted entirely, as noted above. In accordance with one exemplary aspect, the object store 730 is configured to provide a mechanism to traverse all objects in the store.

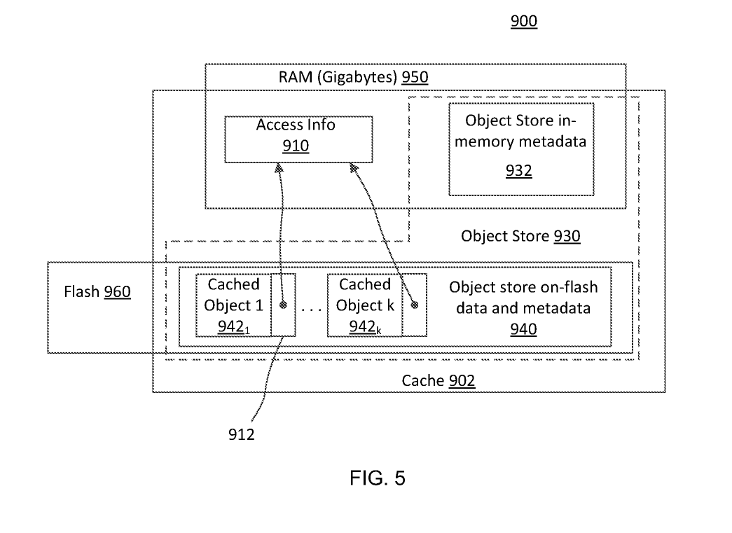

FIG. 5 illustrates an exemplary system 900 in which back-pointer-based methods, such as the method 800 of FIG. 9 can be implemented. Here, the RAM 950 is an implementation of the RAM 202 of the system 200 and the flash memory 960 is an implementation of the SSD 212. The system 900 can further include the processor 206 and the disks 204 of the system 200. The cache 902 is an implementation of the cache 208 and is composed of at least portions of the RAM 950 and the flash memory 960. Further, the access information 910 for each cached object is an implementation of the metadata 210 and is stored in the RAM 950. The system 900 further includes an object store 930, which includes object store in-memory metadata 932 and object store on-flash data and metadata 940. The RAM 950 also stores the object store in-memory metadata 932, the size of which can vary depending on the implementation of the type of memory 960 employed. As stated above, the metadata 932 can be omitted entirely, as any such indices employed by the object store 930 can be stored in the flash 960. The object store data and metadata 940 can be stored in the flash 960. Here, the access information 910 of an object is allocated when the object is inserted into the object store 930 and is deallocated when the object is removed from the object store 930. As discussed in more detail herein below with respect to the method 800 of FIG. 9, the access information 910 can be implemented as a bit array. A substantial advantage of the back-pointer scheme is that the bit array information uses 2 bits per object. Similar to the system 700, the system 900 does not require a full in-memory index. In particular, the scheme avoids an in-memory full index by utilizing a “back-pointer” 912, which is a pointer from flash 960 to memory 950 and is provided with each object 942₁-942ₖ in the cache 902. The back pointer 912 is used to locate the access information of an object, which eliminates the need for a full index. It is noted that Bloom filters need not be used in this technique.

In the exemplary Bloom filter-based embodiments described herein, including, for example, methods 300, 400 and 600, when an object is to be evicted from the cache, the processes iterate through objects in the store, obtain the next key, and lookup that key in the Bloom filter to obtain the access information. As understood in the art, a Bloom filter includes a plurality of slots, where a key is hashed with one or more hashing functions and results in setting one or more of the slots to one. If this key is not present in the Bloom filter (i.e., the bits are zero), the key (and its corresponding data object) is determined to be unreferenced and the corresponding data object is evicted. If a key is present in the present in the Bloom filter when the traversal is implemented, the corresponding data object is not evicted from the cache. The bits of the Bloom filter itself may or may not change depending on whether the process is performed in accordance with BFD or multiple Bloom-filter based schemes. When there is a cache hit, bits of a Bloom filter are marked. In the present description of the exemplary embodiments of the present principles, addition of a key to a Bloom filter and registering a key with a Bloom filter should be understood as marking bits corresponding to the hashes of the key in the Bloom filter as one (or zero). In turn, removal of a key from a Bloom filter, deleting a key from a Bloom filter and deregistering a key from a Bloom filter should be understood as marking bits corresponding to the hashes of the key in the Bloom filter as zero (or one).

With reference now to FIG. 6, an exemplary method 300 for managing cache metadata employing at least one Bloom filter is illustratively depicted. The method 300 is a general implementation of Bloom filter based schemes, of which the Bloom Filter with Deletion scheme and the TBF scheme are more specific exemplary embodiments. Particular details of different ways in which the method 300 can be implemented are described in more detail herein below with respect to the BFD and TBF schemes. It should be noted that the method 300 can be performed by the processor 206 of the system 200 to manage the secondary cache 208. The method 300 can begin at step 302, at which the processor 206 initializes the method 300. For example, the method 300 can be initialized by emptying the one or more Bloom filters employed and initializing the iterator for object keys. At step 304, the processor 206 can receive a request for a data object from a user. At step 306, the processor 206 can determine whether the requested object is in the cache 208. If the requested object is in the cache, then, at step 308, the processor 206 adds or registers the key for the object, which can be a hash key for the object, to or with one or more Bloom filters employed and returns the object from the cache 208. If the processor determines that the requested object is not in the cache, then the processor 206 proceeds to step 307, at which the processor determines whether the cache has sufficient space to store the requested object. If so, then the object is retrieved from the disks 204 and stored in the cache 208. If not, then the processor 206 determines that an eviction should be implemented and proceeds to step 310.

It should be noted that, although the method 300 has been described here as triggering an eviction when a cache miss occurs, steps 304-308 can be replaced with a general determination step 303, at which the processor 206 determines whether a cache eviction condition is met. For example, the processor 206 can be configured to periodically perform cache eviction in the background, where an eviction condition is that a specified amount of time has passed, which triggers the eviction of one or more not recently used objects from the cache. Alternatively, the cache eviction condition can be the receipt of a user-request to purge at least a portion of the cache. In the example illustrated in FIG. 6, steps 306 and 307 provide an implementation of step 303, where a cache miss and insufficient memory in the cache can satisfy an eviction condition.

At step 310, the processor 206 can reference one or more Bloom filters employed. For example, as discussed in more detail herein below, the processor 206 can reference the one or more Bloom filters by iterating through keys for objects in the cache to determine whether any of the keys are not in the one or more Bloom filters. In addition, at step 312, the processor 206 can modify one or more of the Bloom filters. For example, as discussed in more detail herein below, if, during the referencing at step 310, the processor 206 determines that a key is in one or more of the Bloom filters, the processor 206 can implement step 312 by deleting or deregistering the key from the filter to indicate the passage of time (i.e., to indicate that the object was not recently used). The deletion can be performed in an iterative manner, as discussed in more detail herein below. Alternatively, the processor 206 can modify the one or more filters by instituting a switch for a plurality of filters, as discussed in more detail below with respect to the TBF scheme. Here, the switch can alternatively be used to indicate the passage of time and thereby indicate that an object was not recently used. Step 312 need not be performed in cases in which a key for an eviction victim is found on the first reference to the Bloom filter. At step 314, the processor can identify an object to evict from the cache. For example, as discussed in more detail herein below, the processor 206 can identify an object, for eviction, that does not have its key stored in the one or more Bloom filters. At step 316, the processor 206 can evict the identified object from the cache 208. Thereafter, the processor 206 can return to step 307 to determine whether the cache 208 has sufficient space to store the requested object. If not, the processor 206 repeats steps 310-316. If so, then the processor 206, at step 318, can retrieve the requested object from the disk(s) 204 and can store the requested object in the cache 208, as discussed further herein below. Thereafter, another request for an object can be received at step 304 and the process can be repeated.

Referring now to FIG. 7, with continuing reference to FIGS. 2 and 6, an exemplary method 400 for managing a cache employing the Bloom Filter with Deletion scheme is illustratively depicted. As indicated above, the method 400 is an implementation of the method 300. Further, as also indicated above, the method 400 can be performed by the processor 206 in the system 200 to manage the metadata 210 and the data objects in SSD 212 in the cache 208. Here, the cache 208 can store the metadata 210 in a RAM 202 and can store data objects, retrieved from the main storage disks 204, in the SSD 212, which is separate from the RAM 202. Although the SSD 212 is composed of flash memory in this embodiment, the SSD 212 can be composed of phase-change memory or any other type of memory that provides a capacity advantage over DRAM and/or a speed advantage for servicing a request without a cache, such as disk, network, etc. Further, the metadata 210 can include a Bloom filter to track the recent use of data objects in the SSD 212.

The method 400 can begin at step 402, at which the processor 206 initializes the cache system 208. For example, the processor 206 maintains a Bloom filter denoted as “curr_BF” and here, at step 402, the processor 206 empties the Bloom filter curr_BF. In addition, the processor sets the iterator for the method 400 to the first key in the cache. The processor 206 can perform step 402 to implement step 302 of the method 300.

At step 404, which can be performed to implement step 304, the processor 206 receives a request for an object with key k. When an object with key k is requested, the processor 206, at step 406 (which can be performed to implement step 306), looks up the key in the key-value store of the SSD 212 to determine whether the key k is in the cache 208. If the key is found there (i.e., there is a cache hit), the processor 206, at step 408 (which can be performed to implement step 308), marks the key k by inserting or registering k into or with the Bloom filter curr_BF and returns the data object corresponding to key k to the requester from the SSD 212. It should be noted that the key can be inserted into a Bloom filter by hashing the key with one or more hash functions to determine the bit locations in the Bloom filter corresponding to the key and to set the locations to a value of one. The processor 206 can similarly determine whether the key is in the Bloom filter by performing the same procedure and determining whether each of the corresponding bit locations in the Bloom filter are set to one. These aspects of key insertion and key checking with respect to Bloom filters can also be applied in other embodiments, such as the method 600 in FIG. 8, described in detail herein below.

If at step 406, the key k is not found (i.e., there is a cache miss), an object in the SSD 212 is selected for eviction, and the object with key k is inserted into the cache 212. To find a victim, the processor 206 iterates over the objects in the cache 208 until it finds an unmarked object. Because an in-memory index is not employed in this embodiment, the processor 206 relies on the key-value store to provide such iteration capability. Knowledge of the order in which the keys are iterated over is not required. However, any object should appear only once during a traversal of the entire set (an object that has been removed and re-inserted may appear more than once). This property is provided by most key-value stores.

For example, in response to a cache miss at step 406, the processor 206 proceeds to step 410 at which the object is looked up in the disks 204. At step 412, the processor 206 determines whether the cache 212 has sufficient free space to store the object with key k. If the cache 212 does have sufficient space, then the method proceeds to step 414, at which the processor 206 transfers or copies the object corresponding to key k from the disks 204 to the cache 212. Otherwise, the method proceeds to step 416 at which the processor 206 begins the iteration to find an unmarked object to evict.

As stated above with regard to the method 300, it should be noted that although the method 400 has been described here as triggering an eviction when a cache miss occurs, steps 404-412 can be replaced with a general determination step 403, at which the processor 206 determines whether a cache eviction condition is satisfied. For example, as stated above, the processor 206 can be configured to periodically perform cache eviction in the background, where an eviction condition is that a specified amount of time has passed, which triggers the eviction of one or more not recently used objects from the cache. Alternatively, the cache eviction condition can be the receipt of a user-request to purge at least a portion of the cache. In the example illustrated in FIG. 7, steps 404-412 provide an implementation of step 403, where a cache miss and insufficient memory in the cache satisfies an eviction condition.

As indicated above with respect to step 310 of the method 300, the processor 206 can reference the Bloom filter to identify a particular object in the cache to evict. For example, here, at step 416, the processor 206 sets a variable p to the key pointed to by the iterator. Thus, the iteration begins at the same value/position of the iterator at the time an object was most recently inserted into the cache. At step 418, the processor 206 advances the iterator. If the processor 206 reaches the last key, then the iterator is set to the first key. At step 420, the processor 206 references the Bloom filter curr_BF, which includes keys denoting objects in the cache, and determines whether the key p is in the Bloom filter curr_BF. If the key p is in the Bloom filter curr_BF, then the processor 206, at step 422, unmarks an object corresponding to the key p by removing, deleting or deregistering the key p from the Bloom filter curr_BF and then repeats step 416. The removal can be instituted by resetting some or all the bits corresponding to the Bloom filter's hash functions. Here, the deletion of the key can implement step 312 of the method 300. Further, as illustrated in FIG. 8, the modification of the Bloom filter curr_BF can be performed iteratively until the processor 206 determines that a given key for one of the objects in the cache is not in the Bloom filter curr_BF. Removal of a key may be accomplished by choosing at random a subset of the functions used by the Bloom filter and resetting the bits at the corresponding hash-values, where the cardinality of the subset is between 1 and the maximum number of functions used. If the key p is not in the Bloom filter curr_BF, then the processor 206, at step 424 (which can be performed to implement step 316 of the method 300), evicts the object denoted by the key p from the cache 212. Here, determining that the key p is not in the Bloom filter curr_BF essentially identifies the object to evict from the cache (i.e., the object with the key p) and can be performed to implement step 314 of method 300. The method can proceed to step 412 to determine whether sufficient space exists in the cache, as noted above. If so, then the processor 206 then proceeds to step 414, at which the processor 206 transfers or copies the object denoted by the key k from the disks 204 to the cache 212, as noted above. Thus, the eviction process can include evicting a plurality of objects until sufficient space exists to insert the object denoted by the key k in the cache. As such, several objects can be evicted through several iterations of steps 416-424 performed prior to insertion of the requested object denoted by key k in the cache until sufficient space in the cache is obtained to insert the requested object. Thereafter, the system 200 can receive another request for an object at step 404 and the method can be repeated.

It should be noted that the removal of the key by choosing at random a subset of the functions used by the Bloom filter and resetting the bits at the corresponding hash-values can introduce false negatives: removing an element p might cause some other element q to be removed because of collisions between q's hash-values and hash-values in the subset chosen for resetting during p's removal. With the exception of these false negatives, a key returned by the traversal but not found in the Bloom filter corresponds to an object that is in the cache but has not been accessed recently, and thus is a good choice for eviction.

The false positives behavior of standard Bloom filters is understood very well. As such, they can be sized to obtain a low false positive rate; however, introducing a deletion operation not only introduces false negatives, but also changes the calculation for false positives. For example, if only a strict subset of positions is reset, then some bits remain set to one, increasing the false positive rate. The impact of false negatives is discussed in more detail below.

Referring now to FIG. 8, an exemplary method 600 for managing a cache employing the TBF scheme in accordance with an alternative embodiment is illustratively depicted. Similar to the method 400, the method 600 is an implementation of the method 300. Here, the method 600 can be performed by the processor 206 in the system 200 to manage the metadata 210 and the data objects in SSD 212 in the cache 208. The cache 208 can store the metadata 210 in a RAM 202 and can store data objects, retrieved from the main storage disks 204, in the SSD 212, which is separate from the RAM 202. Although the SSD 212 is composed of flash memory in this embodiment, the SSD 212 can be composed of phase-change memory or any other type of memory that provides a capacity advantage over DRAM and/or a speed advantage for servicing a request without a cache, such as disk, network, etc. Further, the metadata 210 can include a plurality of Bloom filters to track the recent use of data objects in the SSD 212. For example, while BFD permits the processor 206 to immediately remove a key from the Bloom filter once the object has been evicted from the cache, it is noted that this removal need not be immediate; in this embodiment, an object that is considered for eviction will only be considered again after all other objects have been considered. Until then, the object's marked or unmarked status is irrelevant. Thus, two Bloom sub-filters can be used to manage the cache 208, where many elements can be dropped in bulk by resetting an entire sub-filter.

As noted above, in TBF, two Bloom sub-filters are maintained in the cache-metadata 210: one current, curr_BF, and one previous, prev_BF. The current filter curr_BF is used to mark any keys that are cache hits; to evict, the processor 206 searches, for example, by traversing the key-value store, for keys that are not marked in any of the filters. Periodically, prev_BF is discarded, and the previous filter is logically replaced with the current filter, and current filter becomes a new (empty) Bloom sub-filter; this operation is denoted herein as a “flip” or a “switch.”

There are several options with regard to when the system should institute a flip. One possibility is to keep marking elements in the current Bloom sub-filter until it has an equal number of bits zero and one. In some sense this is when the sub-filter is “full” a Bloom filter sized to accommodate 11 objects will have roughly equal number of zero and one bits after n distinct insertions. However, as indicated above, the system 200 in this embodiment marks objects by inserting them in the current Bloom sub-filter when a key is accessed. A workload that has high locality of reference will lead to a very slow accumulation of ones in the Bloom filter. This has the undesirable effect of keeping rarely accessed objects marked in the Bloom filter together with the frequently accessed objects for a long time.

Because the Bloom filter is not itself the cache, but rather keeps only access information in this embodiment, it need not be kept until it is full. Rather, the point is to provide information regarding whether an object has been accessed recently. Because of this, another option is employed in which a flip is implemented after the processor 206 traverses a number of objects equal to the cache size (in objects). This permits the TBF scheme to provide an approximation of a useful property in this exemplary embodiment: an accessed object survives in the cache for at least one full traversal (all other keys must be considered for eviction before this object is evicted). In fact, the TBF scheme in this embodiment “remembers” access information from between one and two full periods, somewhat similar to a counting-clock variation (with a maximum count of two).

Referring in detail to the method 600 in FIG. 8, the method can begin at step 602, at which the processor 206 initializes the cache system 208. For example, as noted above, the processor 206 maintains a current Bloom filter denoted as “curr_BF” and a previous Bloom filter denoted as “prev_BF.” Here, at step 602, the processor 206 empties the current Bloom filter curr_BF and the previous Bloom filter prev_BF. In addition, the processor sets the iterator for the method 600 to the first key in the cache. The processor 206 can perform step 602 to implement step 302 of the method 300.

It should be noted that although the method 600 employs two sub-filters, the method can be generalized to 1 . . . K sub-filters, where, upon a switch at step 624, described below, sub-filter “1” is emptied and is designated as the most current sub-filter “K,” sub-filter “2” is designated as sub-filter “1,” sub-filter “3” is designated as sub-filter “2,” etc. The process repeats at a subsequent iteration of step 624.

At step 604, which can be performed to implement step 304, the processor 206 receives a request for an object with key k. When an object with key k is requested, the processor 206, at step 606 (which can be performed to implement step 306), looks up the key in the key-value store of the SSD 212 to determine whether the key k is in the cache 208. If the key found there (i.e., there is a cache hit), the processor 206, at step 608 (which can be performed to implement step 308), marks the key k by inserting or registering k into or with the Bloom filter curr_BF and returns the data object corresponding to key k to the requester from the SSD 212.

If, at step 606, the key k is not found (i.e., there is a cache miss), a victim object in the SSD 212 is selected for eviction, and the object with key k is inserted into the cache 212. To find a victim, the processor 206 iterates over the objects in the cache 208 by, for example, employing the key-value store, as discussed above. For example, in response to a cache miss at step 606, the processor 206 proceeds to step 610 at which the object is looked up in the disks 204. At step 612, the processor 206 determines whether the cache 212 has sufficient free space to store the object with key k. If the cache 212 does have sufficient space, then the method proceeds to step 614, at which the processor 206 transfers or copies the object corresponding to key k from the disks 204 to the cache 212. Otherwise, the method proceeds to step 616 at which the processor 206 begins the iteration to find an object to evict.

As stated above with regard to the method 300, it should be noted that although the method 600 has been described here as triggering an eviction when a cache miss occurs, steps 604-612 can be replaced with a general determination step 603, at which the processor 206 determines whether a cache eviction condition is satisfied. For example, as stated above, the processor 206 can be configured to periodically perform cache eviction in the background, where an eviction condition is that a specified amount of time has passed, which triggers the eviction of one or more not recently used objects from the cache. Alternatively, the cache eviction condition can be the receipt of a user-request to purge at least a portion of the cache. In the example illustrated in FIG. 8, steps 606 and 612 provide an implementation of step 603, where a cache miss and insufficient memory to store the requested object satisfies an eviction condition.

As indicated above with respect to step 310 of the method 300, the processor 206 can reference the Bloom filter to identify a particular object in the cache to evict. For example, here, at step 616, the processor 206 sets a variable p to the key pointed to by the iterator. Thus, as noted above with respect to the method 400, the iteration begins at the same value/position of the iterator at the time an object was most recently inserted into the cache. At step 618, the processor 206 advances the iterator. If the processor 206 reaches the last key, then the iterator is set to the first key. At step 620, the processor 206 references the Bloom filter curr_BF and the Bloom filter prey BF and determines whether the key p is in at least one of the Bloom filter curr_BF or the previous Bloom filter prev_BF. If the key p is in at least one of curr_BF or prev_BF, then the method proceeds to step 622, at which the processor 206 determines whether a maximum number of keys has been traversed by steps 618 and 620. For example, the maximum number of keys can correspond to a number of objects equal to the cache 212 size in objects. As noted above, the flip can be triggered when a number of objects equal to the cache 212 size in objects is traversed in the iteration. If the maximum number of keys has not been traversed, then the method proceeds to step 616 and the processor 206 can implement another iteration. If the maximum number of keys has been traversed, then a flip is instituted at step 624, where the processor 206 sets the values of prey BF to the values of curr_BF and empties curr_BF. Here, the flip performed at step 624 can constitute the modification of the Bloom filters at step 312 of the method 300. In one implementation, the maximum number of keys can be the total number of keys in the cache or a substantial part of the total number of keys in the cache. Thus, in this implementation, step 624 can be performed at the end of each “cycle,” where a cycle corresponds to an entire traversal, or a substantial part of the traversal. It should be noted that the maximum number of keys is just one example of a threshold. The threshold can be based on time elapsed or other predetermined quantities. Thereafter, the method can proceed to step 616 and the processor 206 can implement another iteration.

Returning to step 620, if the key p is not in at least one of the current Bloom filter curr_BF or the previous Bloom filter prev_BF, then the method can proceed to step 626 (which can be performed to implement step 316 of the method 300), at which the processor 206 evicts the object corresponding to key p from the cache 212. Here, determining that the key p is not in either the Bloom filter curr_BF or the Bloom filter prev_BF essentially identifies the object to evict from the cache (i.e., the object with the key p) and can be performed to implement step 314 of method 300. The method can proceed to step 612 to determine whether sufficient space exists in the cache, as noted above. If so, then the processor 206 then proceeds to step 614, at which the processor 206 transfers or copies the object corresponding to key k from the disks 204 to the cache 212, as noted above. Similar to the method 400, the eviction process can include evicting a plurality of objects through several iterations of steps 616-624 until sufficient space exists to insert the object denoted by the key k in the cache. Thereafter, the system 200 can receive another request for an object at step 604 and the method can be repeated.

It is important to note that, while BFD and TBF in the embodiments described above have behavior similar to that of CLOCK, there are at least three important differences. The first is that the traversal potentially involves the implementation of I/O operations by the key-value store on flash. In practice, an upper bound on the amount of time it takes to find a victim and evict it in order to bring into the cache the newly accessed object should be imposed. Stopping the traversal before an unmarked object is found potentially results in poor eviction decisions. The impact of the key-value store traversal on the caching policy is discussed in more detail herein below.

The second difference is that CLOCK inserts new objects “behind” the hand; thus, a newly inserted object is only considered for eviction after all other objects in the cache at the time of its insertion are considered. However, in the exemplary embodiments described above, the traversal order is decided by the key-value store implementation and this property might not be satisfied. For example, a log-structured key-value store will provide this property, while a key-value store with a B-tree index will not. Note that newly inserted objects might be encountered during the traversal before all the old objects are visited. Because of this, a complete traversal might visit a number of objects higher than the cache size. In such a case, curr_BF might be populated with more keys than intended. This provides another reason for replacing prev_BF with cur_BF after some criteria have been satisfied other than reaching the last object in the cache, such as some number of objects having been traversed.

The third difference comes from the fact that Bloom filters have false positives; this affects both TBF and BFD. Additionally, BFD has false negatives as well.

Returning to keyore traversal employed in the exemplary embodiments described above, it is noted that there are two main concerns regarding the traversal. First, unlike the case in which the entire set of keys is stored in memory, iterating over the key-value store on flash incurs an I/O cost. This cost should be kept low. Second, it is possible that the key-value store traversal encounters a long sequence of marked objects. At an extreme, it is possible for all objects to be accessed between two traversals. The cost of traversal should be bounded even in the worst case in order to avoid unpredictable latencies.

A simple, practical scheme, is to limit the amount of time spent searching for a victim to the amount of time it takes to service from the disk 204 the cache miss. The number of keys traversed during this time varies not only with the types of flash and disk devices, but also with the internal organization of the key-value store on flash. A key-value store that has an index separate from the data—for example it has a B-tree index—will bring in memory, on average, many keys with just one I/O operation. A key-value store that keeps data and metadata together—for example it has a hashtable organization—might bring in memory just one key per I/O. Even in such a case, however, the number of keys on flash traversed during one disk I/O is on average the ratio of random reads on flash to random reads on disk; since caches are typically deployed when their latencies are at least an order of magnitude lower than that of the slower devices, it is expected that, at a minimum, the traversal can return ten keys per evicted object.

The number of keys that have to be traversed on average to find a victim depends on whether the objects newly inserted into the cache are marked or not. For in-memory caches, both variations are used. They offer the following trade-offs: if inserted unmarked, an object that is not subsequently accessed will be evicted more quickly (allowing other, potentially useful, objects to remain in the cache longer); however, an object that has a reuse distance, defined as the cardinality of the set of items accessed in between the two accesses to the object, that is smaller than the cache size can still be evicted before being reused, whereas it would have been kept if marked on insertion.

It can be shown that marking objects on insertion increases the average number of keys visited by the traversal by 40-60%. It also causes longer stretches of marked objects. This leads to a higher number of poor evictions (where we have to evict a marked object). Since having a higher number of traversals and a higher number of poor evictions are both undesirable, the preferred embodiment leaves objects unmarked on insertion.

Experiments have shown that higher cache hit rates lead to increased traversal per eviction, but to a lower total traversal cost. Because fewer evictions are made depending on the traversal provided by the key-value store, any poor evictions are likely to be either random or FIFO. In TBF, the system can perform somewhat better than random for those situations, as the two Bloom filters can also indicate that some items were marked more recently than others.

It should be noted, with regard to insertion order, CLOCK considers objects for eviction in the order in which they were inserted into the cache, thus guaranteeing that a newly inserted object will only be considered for eviction after all other objects in the cache are considered. In the exemplary embodiments described above, the keys are not in memory, and both the traversal and the positions at which keys are inserted are imposed by the key-value store. Thus, this property might not hold (although there are cases where it might, such as a log-structured key-value store that provides the traversal in log order).

On average, for uncorrelated traversal and insertion orders, a newly inserted object is considered for eviction after half the number of objects in the cache have been traversed. The system could guarantee that all other objects are considered at least once before the newly inserted object by marking the objects on insertion; however, as discussed above, this increases the amount of keys visited by the traversal. If the I/O cost for traversal is not high, as in the case of key-value stores that have an index separated from the data and thus the key traversal can be done with little I/O, marking the objects on insertion might be preferable.

Turning now to the issue of false positives and false negatives, preliminarily, it is noted that the existence of false negatives and false positives in identifying marked objects is not a correctness issue. In the embodiments described above, the Bloom filter lookup is not used to determine whether an object is in the cache or not that is left to the key-value store; rather, it is used to decide evictions. As such, incorrect access information leads to a poor eviction decision. Whether this is tolerable depends on the impact on the cache hit ratio.

A false negative arises when the traversal encounters an object that has been accessed since the last traversal but its lookup fails (returns not-marked), leading to the object's incorrect eviction. The penalty for false negatives should be small in practice. The intuition is that a frequently accessed object, even if removed by mistake (through collision), will likely be accessed again before it is visited by the traversal. Further, the eviction of infrequently accessed objects will likely not be too detrimental. For an incorrect eviction, the following conjunction of events occurs: the object O₁ is accessed at some time t₁; some other object O₂ with which O₁ collides is traversed at time t₂>t₁ before the traversal reaches O₁ again; at least one of the bit positions on which O₂ collides with O₁ is actually among those that are reset; there are no other accesses to O₁ before the traversal encounters it again. For frequently accessed objects, these conditions are expected to be rarely met at the same time.

A false positive arises when the traversal encounters an object that was not accessed since the last traversal, but the Bloom filter has all the bits corresponding to that key's hash functions set to 1. In addition to the reason a standard Bloom filter (SBF) has false positives, a Bloom filter with deletion might have additional false positives if the deletion operation does not reset all the bits. The lower the false positive rate (FPR), the lower the fraction of objects that are kept in memory by mistake and pollute the cache. The first component of the FPR in standard Bloom filters (SBFs) can be kept low with only a few bits per object; for example, to achieve an FPR<0.01, an SBF employs only 10 bits per object when using 5 hash functions. The size of the second component of the false positive rate for BFD is discussed further below. Note that this second component can actually be reduced to zero if all the bit positions are reset during the removal operation at step 422. It is important to note that an object kept in the cache through error does not necessarily remain in the cache forever; as indicated above, in the BFD embodiment discussed above, the traversal resets the bits of the objects that are not evicted.

One goal of the system is to provide a good approximation with as few bits as possible. A Bloom filter's false positives depends of the ratio m/n, where m is the number of bits and n is the number of objects inserted into the Bloom filter, and k the number of hash functions used. Usually, a Bloom filter is sized based on n, the number of keys it needs to accommodate. However, in the implementations discussed above, n does not represent the total number of objects in the cache; rather, it depends on the number of marked objects, which is not known a priori, as it depends on the workload's locality.

To obtain a false positive rate in the single digits, 4 bits can be used per cached object Depending on the actual distribution of hits, this corresponds to between 4 and 8 bits per marked object. With regard to the number of hash functions used in the Bloom filters, the optimal number depends on m/n. In practice, the ratio is expected to be higher than 4, although not quite reaching 8 because the false positives feed back into the algorithm by increasing the number of apparently marked objects, which decreases m/n by increasing n. To strike a balance, 3 hash functions can be employed, which should work well over the range of likely m/n ratios. Experiments have shown that the Bloom filter false positives actually increases somewhat the ratio of marked objects in the cache.

The TBF embodiment described above has a small amount of positive deviations at all cache sizes, and no negative deviations. Of the positive deviations, some are due to Bloom filter collisions, but others are due to the fact that TBF preserves access information beyond one full traversal; CLOCK maintains access information for an object for exactly one traversal. TBF keeps the object marked for longer: an unused object will survive in the current Bloom filter up to, at most, one full traversal, and will survive in the previous Bloom filter for another full traversal. Thus, the TBF embodiment described above occasionally keeps in memory objects with a reuse distance longer than the cache size. For traces in which the distribution of the object's reuse distance does not have an abrupt drop exactly at the cache size, TBF is expected to perform at least slightly better than CLOCK. Note that a greater number of marked objects causes the traversal to visit a greater number of objects until an unmarked object is found, and thus to move “faster.”

Referring now to FIG. 9, with continuing reference to FIG. 2, method 800 for managing a cache employing an in-memory bit array in accordance with an alternative embodiment is illustratively depicted. Prior to discussing the method in detail, it should be noted that, similar to the Bloom filter-based methods described above, the present method can be implemented so that an in-memory dictionary is not utilized. For example, as indicated above, recency-based caching algorithms use two data structures: an access data structure that maintains the recency information and a dictionary (index) that maps an object's key to its associated recency information. For faster access, these data structures are maintained in RAM; thus, they incur memory overhead. To save memory, the present principles can decouple the access data structure from the index structure of a cache implementation. Here, in this exemplary embodiment, an in-memory bit array can be used to keep track of access information without maintaining any in-memory dictionary. The underlying on-flash key-value store's capability may be leveraged to iterate over cached objects in order to perform the search for good eviction victims. Thus, traversal order is given by the key-value store. However, the design is agnostic to the key-value store as long as it provides a method to iterate over its key, which is an operation that is commonly supported. The object id can be stored as the key and its contents can be stored as a value in the key-value store.

Similar to the embodiments described above, it should be noted that the method 800 can be performed by the processor 206 in the system 200 to manage the metadata 210 and the data objects in SSD 212 in the cache 208. Here, the cache 208 can store the metadata 210 in a RAM 202 and can store data objects, retrieved from the main storage disks 204, in the SSD 212, which is separate from the RAM 202. In particular, the processor 206 can store and/or reference a bit array as the metadata 210 in the RAM 202. Because an in-memory dictionary is not employed in this embodiment, the processor 206 employs a mechanism to associate access information in the bit-array to the corresponding key stored in the key-value store. To this end, the in-memory bit-offset information can be stored in the key-value store of the SSD 212 for an object along with its key to identify the bit location or slot in the array corresponding to this object. This offset aids the processor 206 in quickly finding the access information in the bit array. Thus, for every object in the cache 208, the processor 206 stores its key value plus bit-offset information in the key-value store of the SSD 212. Use of bit offset information aids in saving memory, although it uses some extra space in the SSD 212. As such, the RAM 202 stores metadata for the data objects that includes a bit array while the SSD 212 stores data objects, keys denoting the data objects in the cache 208, and bit offset information for each of the keys denoting different slots in the bit array. As indicated above, the SSD 212 can be composed of flash memory elements in this embodiment. However, in alternative embodiments, cache store 212 can be composed of phase-change memory, or any other type of memory or storage that offers a capacity advantage over DRAM and/or a speed advantage over servicing the request without a cache, such as disk, network, etc. The system uses an in-memory bit array to keep track of access information and does not maintain any in-memory dictionary to keep track of cached object in this embodiment. The functionality of the dictionary is provided by the on-flash key-value store.

In accordance with one exemplary aspect, in the bit array 210, one of three possible states can be maintained for every object: set, reset, and free. It is noted that, in contrast to the traditional bit array, where every slot has two states of zero (reset) and one (set), one additional state is employed to keep track of “free.” To solve this problem, in the bit array for every key, 2 bits are allocated in a slot. These two bits enable the processor 206 in to keep track of their states: zero (or reset) (00), one (or set) (01), and free (11). The “10” state is reserved for the future use. All slots are initially marked as free. Thus, two bits can be stored per cached object; further, the two bits are allocated as one slot. It should be noted that even less than two bits can be utilized per cached object if packing techniques are employed.

In order to quickly find free slots in the bit-array, an in-memory (i.e. in RAM 202 in this embodiment) free-slot cache can be employed. The processor 206 can be configured to periodically scan the bit array to populate this cache. This helps to amortize the cost of finding free slots. The free-slot cache can be very small in terms of the amount of memory it employs. In one implementation, the free-slot cache contains only 128-1024 entries. Thus, the memory overhead is 1 KB-8 KB, assuming every entry takes 8 bytes. Whenever an object is evicted, its slot information is added to the free-slot cache, for example, as discussed in more detail with respect to step 814 below. If the free-slot cache is empty and the system needs a free slot, the processor 206 can scan the bit-array 210 to find free slots and insert them in free-slot cache. The processor can continue scanning until the free-slot cache is full. Thus, the system need not scan every time it needs a free slot, thereby amortizing overall free slot lookup cost.

Referring now in detail to FIG. 9, the method 800 can begin at step 802, in which the processor 206 can mark all slots in the in-memory bit array 210 as free. Further, the processor 206 can set the iterator of the key value-store of the SSD 212 to the first key in the store.

At step 804, the processor 206 can receive a request for a data object.

At step 806, the processor 206 can determine whether the requested object, having the key k, is in the cache 208. For example, in this embodiment, the processor 206 can lookup the key in the on-flash key-value store of the SSD 212.

If the key k (and its corresponding object) is in the cache 208, then the processor 206 can proceed to step 808, at which the processor 206 can set the bit slot of the bit array 210 associated with the requested object to a set state. For example, if there is a cache hit, the processor 206 can immediately serve the value from the SSD 212, read bit-offset information from the cache and set the corresponding in-memory bit to 01.

Otherwise, if the processor 206 determines that the key k for the requested object is not in the cache 208 at step 806, then the processor 206 can proceed to step 810, at which the requested object is looked up in the disks 204. At step 812, the processor 206 determines whether the cache 212 has sufficient free space to store the object with key k. If the cache 212 does have sufficient free space, then the method proceeds to step 814, at which the processor 206 reads the value of the object corresponding to key k from the disks 204, serves the request and inserts the data object (e.g., value of the object) corresponding to key k and the key k to the cache 212. Further, also at step 814, the processor 206 finds a free slot in the in-memory bit-array 210 and saves the corresponding bit offset information that identifies this free slot with the key k in the key-value store of the SSD 212. In this way, a free slot from the free-slot cache can be associated with the requested object in the bit offset information for the object. Once the slot is associated with an object, the slot is no longer free. Thus, the bit value of this slot is also set to a reset state by the processor 206 at step 814. A variation of this method sets the value of this slot to a set state. Whether a new object inserted into the cache has the associated slot set to a set or reset state represents a trade-off similar to that of the standard CLOCK algorithm. If the free-slot cache is empty, then the processor 206 can scan the bit-array and can add free slots to the free-slot cache until the free-slot cache is full.

If, at step 812, the processor 206 determines that the cache 212 does not have sufficient memory to store the requested object, then the processor can begin an iterative process for evicting one or more objects.

Similar to the method 300, it should be noted that although the method 800 has been described here as triggering an eviction when a cache miss occurs, steps 804-812 can be replaced with a general determination step 803, at which the processor 206 determines whether a cache eviction condition is satisfied. For example, as stated above, the processor 206 can be configured to periodically perform cache eviction in the background, where an eviction condition is that a specified amount of time has passed, which triggers the eviction of one or more not recently used objects from the cache. Alternatively, the cache eviction condition can be the receipt of a user-request to purge at least a portion of the cache. In the example illustrated in FIG. 9, steps 806 and 812 provide an implementation of step 803, where a cache miss and insufficient memory in the cache satisfies an eviction condition.

To find an eviction victim, the processor can traverse the key-value store using its iterator. Thus, at step 816, the processor 206 sets a variable p to the key pointed to by the iterator. As noted above with respect to other method embodiments, the iteration begins at the same value/position of the iterator at the time an object was most recently inserted into the cache. At step 818, the processor 206 advances the iterator. If the processor 206 reaches the last key, then the iterator is set to the first key. The processor 206 iterates over the keys in the cache until a key p is found such that the bit-slot corresponding to p is in the reset (00) state.

Thus, at step 820, the processor 206 determines whether the bit slot (of the bit array stored in metadata 210) that is associated with the object denoted by key p is set to a reset state. For example, if the bit slot is set to a set state, then the bit slot indicates that the object associated with the bit slot was recently used. For every traversed key, the processor 206 references the on-flash bit-offset information for the object denoted by the key p to determine in which slot in the bit-array to check the access information. If the bit in the determined slot is set to a set state (01 in the example provided above), then, at step 822, the processor 206 resets the bit to a reset state (00 in the example provided above) and the processor 206 proceeds to steps 816 and examines the next object in the key value store of the SSD 212. The processor 206 can perform a plurality of iterations of steps 816-822 until it identifies an object for eviction.

If, at step 820, the processor 820 determines that the bit slot of the bit array stored in metadata 210 that is associated with the object denoted by key p is set to a reset state, then the method proceeds to step 823, in which the processor identifies the object denoted by key p for eviction. As indicated above, if the bit slot is set to a reset state, then the bit slot indicates that the object associated with the bit slot was not recently used and should be evicted. At step 824, the processor 206 evicts the data object denoted by key p from the SSD 212, marks the in-memory bit slot associated with this object as free (11), and adds the bit slot information to the free-slot cache. The method can proceed to step 812 to determine whether sufficient space exists in the cache, as noted above. If so, then, thereafter, the processor 206 can perform step 814, as discussed above. In addition, the processor 206 of system 200 can receive a request for another object at step 804 and the method can be repeated. It should be noted that the eviction process can include evicting a plurality of objects until sufficient space exists to insert the object denoted by the key k in the cache. Thus, several objects can be evicted through several iterations of steps 816-824 performed prior to insertion of the requested object denoted by key k in the cache until sufficient space in the cache is obtained to insert the requested object.

The method 800, as well as the other exemplary embodiments described herein, provides distinct advantages over current schemes for caching data. For example, as indicated above, current schemes require the use of an in-memory index for all cached keys, which necessitates at least four bytes per object for very large stores. However, employing an in-memory bit array or Bloom filters in accordance with the present principles can achieve similar performance while utilizing less memory for tracking cache accesses. For example, the BFD or TBF schemes described above utilize one or two bytes per object, while the in-memory bit array method uses two bits per object. Further, the efficiency provided by the present principles is especially advantageous for very large capacity caches, such as flash memory systems, phase change memory devices and the like.

Having described preferred embodiments of memory-efficient caching methods and systems (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for managing a cache comprising:
determining whether a cache eviction condition is satisfied;
in response to determining that the cache eviction condition is satisfied, referencing at least one Bloom filter registering keys denoting objects in the cache to identify a particular object in the cache to evict; and
evicting the particular object from the cache.

2. The method of claim 1, further comprising:
in response to determining that the cache eviction condition is satisfied, iteratively modifying the at least one Bloom filter by deregistering at least one of the keys until determining that a given key for one of the objects in the cache is not registered in the at least one Bloom filter.

3. The method of claim 2, wherein the identifying comprises identifying the object denoted by the given key as the particular object in the cache to evict.

4. The method of claim 1, wherein the at least one Bloom filter includes a current Bloom filter and a previous Bloom filter.

5. The method of claim 4, wherein the method further comprises:
modifying the previous Bloom filter and the current Bloom filter by setting values of the previous Bloom filter to values in the current Bloom filter and emptying the current Bloom filter.

6. The method of claim 5, wherein the modifying is performed in response to determining that a threshold has been reached during said referencing.

7. The method of claim 1, further comprising:
registering a key denoting a requested object in the at least one Bloom filter in response to determining that the requested object is in the cache.

8. A caching system comprising:
a main storage element configured to store data;
a cache configured to store data objects and metadata for the data objects that includes at least one Bloom filter; and
a processor configured to reference the at least one Bloom filter registering keys denoting the data objects in the cache to identify which of the data objects in the cache to evict in response to determining that a cache eviction condition is satisfied.

9. The system of claim 8, wherein the metadata is stored on at least one first memory element that is separate from at least one second memory element on which said data objects are stored.

10. The system of claim 9, wherein the at least one first memory element comprises random access memory, wherein the at least one second memory element comprises flash memory, and wherein the main storage element comprises at least one storage disk.

11. The system of claim 8, wherein the processor is configured to, in response to determining that the cache eviction condition is satisfied, iteratively modify the at least one Bloom filter by deregistering at least one of the keys until determining that a given key for one of the objects in the cache is not registered in the at least one Bloom filter.

12. The system of claim 11, wherein the processor is further configured to evict the object denoted by the given key.

13. The system of claim 8, wherein the at least one Bloom filter includes a current Bloom filter and a previous Bloom filter and wherein the processor is further configured to set values of the previous Bloom filter to values in the current Bloom filter and to empty the current Bloom filter.

14. The system of claim 13, wherein the processor is further configured to set the values of the previous Bloom filter to the values in the current Bloom filter and to empty the current Bloom filter in response to determining that a threshold has been reached while referencing the previous and current Bloom filters to identify which of the data objects in the cache to evict.

15. A caching system comprising:
a main storage element configured to store data;
a cache including at least one first element configured to store metadata for data objects that includes a bit array and at least one second element configured to store the data objects, wherein the at least one second element includes keys denoting the data objects in the cache and includes bit offset information for each of the keys denoting different slots in the bit array; and
a processor configured to identify, in response to determining that a cache eviction condition is satisfied, a particular data object in the cache to evict by deter Wining whether the slot in the bit array corresponding to the particular data object indicates that the particular data object was recently used.

16. The system of claim 15, wherein the at least one first element comprises random access memory, wherein the at least one second element comprises flash memory, and wherein the main storage element comprises at least one storage disk.

17. The system of claim 15, wherein each of the slots of the bit array denote one of a set state, reset state or free state.

18. The system of claim 17, wherein the processor is further configured to evict the particular data object from the cache in response to determining that the slot in the bit array corresponding to the particular data object is in a reset state and wherein the processor is further configured to set the slot in the bit array corresponding to the particular data object to a free state.

19. The system of claim 17, wherein the processor is further configured to receive a request for a given data object and to
set the slot corresponding to the given data object to a set state if the given data object is in the cache, and
add the given data object to the cache and associate any free state slot in the bit array with the given data object in bit offset information for the given data object if the given data object is not in the cache.

20. The system of claim 17, wherein the processor is further configured to, in response to determining that the cache eviction condition is satisfied, reset at least one of the slots of the hit array from a set state to a reset state prior to identifying the particular data object.
